(19) United States
(12) Patent Application Publication
(10) Pub. No.: US 2026/0243035 A1
(43) Pub. Date: Aug. 20, 2026

(54) ROAD TRAFFIC SIGNAL DEVICE EXTENSIBLE IN BOTH DIRECTIONS AND ROAD TRAFFIC SIGNAL VEHICLE EMPLOYING THE SAME

(71) Applicant: JB SOLUTION CO., LTD., Sejong (KR)

(72) Inventor: Sang Moon PARK, Sejong (KR)

(21) Appl. No.: 19/322,196

(22) Filed: Sep. 8, 2025

(30) Foreign Application Priority Data
Feb. 19, 2025 (KR) 10-2025-0021394
Aug. 4, 2025 (KR) 10-2025-0106401

(51) Int. Cl. E01F 9/662; E01F 9/696; G08G 1/0955

(52) U.S. Cl. CPC E01F 9/662; E01F 9/696; G08G 1/0955

(57) ABSTRACT

Proposed is a road traffic signal device that can deploy traffic sign display panels in both directions with respect to a movable platform and a road traffic signal vehicle employing the road traffic signal device. The road traffic signal vehicle may include a movable platform and a road traffic signal device installed on the movable platform and configured to deploy traffic sign display panels in both directions with respect to the movable platform.

### CROSS-REFERENCE TO RELATED APPLICATIONS

The present claims a convention priority under 35 U.S.C. § 119(a) based on Korean Patent Application No. 10-2025-0021394 filed on Feb. 19, 2025, Korean Patent Application No. 10-2025-0106401 filed on Aug. 4, 2025, the entire content of which is incorporated herein in its entirety by reference.

### BACKGROUND

### Technical Field

The present disclosure relates to a road traffic signal vehicle and, more particularly, to a road traffic signal device capable of deploying traffic sign display panels in both directions with respect to a movable platform and a road traffic signal vehicle employing the road traffic signal device.

### Description of Related Technology

During pavements and maintenance works on highways, expressways, or another general roadways, various types of safety indicators such as stop signals, warning lights, or driving direction indicators are installed ahead of roadwork areas to alert oncoming drivers.

### SUMMARY

One aspect is a road traffic signal device capable of deploying traffic sign display panels in both directions, so that the traffic sign display panels span across all lanes of a road, using a single road traffic signal vehicle disposed on one or more lanes of the road, and a road traffic signal vehicle employing the road traffic signal device.

It is to be understood that aspects are not limited to those described herein, and other aspects not mentioned herein will become apparent to those skilled in the art from the following description.

Another aspect is a road traffic signal vehicle including: a movable platform and a road traffic signal device installed on the movable platform and configured to deploy traffic sign display panels in both directions with respect to the movable platform.

The road traffic signal device may include: a boom module comprising a multi-stage boom that may be extended in both directions so as to span across a plurality of lanes of a road above the plurality of lanes; and the traffic sign display panels installed at the multi-stage boom and configured to be movable to over a corresponding lane of the road when the multi-stage boom is deployed to indicate whether the corresponding lane is available for driving.

The boom module may include: a drive table is installed on the movable platform to be rotatable in a horizontal direction; a rotating frame installed on the drive table; and the multi-stage boom coupled to the rotating frame with an intervention of a connecting frame.

The multi-stage boom may include: a first multi-stage boom coupled to the connecting frame and extensible in a first direction; and a second multi-stage boom installed at one side of the first multi-stage boom and extensible in a second direction opposite to the first direction.

The first multi-stage boom may include a plurality of first boom segments expanding or retracting telescopically.

The second multi-stage boom may include one or more second boom segments and is extended or folded by rotating around one or more hinges.

The second multi-stage boom may be rotatably coupled to one end of the first multi-stage boom opposite to the direction in which the first multi-stage boom is extensible. The second multi-stage boom may be parked on one side of the first multi-stage boom in a folded state. When the second multi-stage boom is to be extended, the second multi-stage boom may be rotated and extended to the second direction opposite to the first direction in which the first multi-stage boom is extended.

The traffic sign display panels may be installed on one side or both sides of the multi-stage boom.

The road traffic signal vehicle according to an exemplary embodiment may further include at least one of: a plurality of outriggers installed at the movable platform to be expandable and retractable so as to support the road traffic signal vehicle; a work light installed at an upper portion of the movable platform; and a shock absorbing structure installed at a side of the movable platform opposite to a side at which a vehicle body is coupled.

The road traffic signal device may be capable of deploying the traffic sign display panels in only one direction with respect to the movable platform.

The movable platform may include a stage of the vehicle or a trailer.

According to another aspect of an exemplary embodiment, the present disclosure provides a road traffic signal device installed on a movable platform and configured to deploy traffic sign display panels in both directions with respect to the movable platform.

Since the road traffic signal vehicle according to the present disclosure is capable of deploying the traffic sign display panels in both directions with respect to the movable platform, the road traffic signal vehicle can provide traffic signs by deploying the traffic sign display panels over a plurality of lanes of the road while being disposed in the middle of the road. Thus, just a single road traffic signal vehicle disposed in the middle of the road on which the roadwork is underway can provide sufficient information to the vehicles driving toward the roadwork site and allows to perform a construction operation with an enhanced safety.

Meanwhile, in case where the traffic signal vehicle according to the present disclosure is disposed on the shoulder of the road, only the traffic sign display panels installed on the road side among the traffic sign display panels may be deployed toward the lanes of the road similarly to an existing road traffic signal vehicle.

The advantages of the present disclosure at not limited to those described above, and other advantages not mentioned herein will become apparent to those skilled in the art from the following description of the embodiments of the present disclosure.

### BRIEF DESCRIPTION OF THE DRAWINGS

In order that the disclosure may be well understood, there will now be described various forms thereof, given by way of example, reference being made to the accompanying drawings.

FIG. 1 is a perspective view showing a multi-stage boom of a road traffic signal vehicle according to a first exemplary embodiment of the present disclosure.

FIG. 2 is a plan view of the road traffic signal vehicle shown in FIG. 1 and shows a state before a boom module is expanded.

FIGS. 3-6 are plan views of the road traffic signal vehicle showing the deployment of the boom module.

FIG. 3 is a plan view of road traffic signal vehicle showing a state in which the multi-stage booms are rotated to a direction perpendicular to the traveling direction of the vehicle for the deployment of the boom module.

FIG. 4 is a plan view of the road traffic signal vehicle showing a state in which only a first multi-stage boom among two multi-stage booms is deployed in one direction (i.e., to the left) with respect to a movable platform.

FIG. 5 is a plan view of the road traffic signal vehicle showing a state in which a second multi-stage boom among the multi-stage booms is deployed in the other direction (i.e., to the right) with respect to the movable platform.

FIG. 6 is a plan view of the road traffic signal vehicle showing a state in which the first and second multi-stage booms are deployed in both directions with respect to the movable platform.

FIG. 7 is a perspective view showing multi-stage booms of a road traffic signal vehicle according to a second exemplary embodiment of the present disclosure.

The drawings described herein are for illustration purposes only and are not intended to limit the scope of the present disclosure in any way.

### DETAILED DESCRIPTION

Drivers of vehicles in motion can perceive the roadwork areas in progress ahead by observing the safety indicators. However, when a large vehicle or structure obstruct the driver's line of sight to the roadwork area, it is probable that the driver cannot receive a proper guidance on available driving lanes, which may result in a safety accident such as a collision with a work vehicle or a worker.

To address this issue, when a traffic control is necessary, workers equipped with radios may communicate with each other to share traffic conditions and manually direct vehicles using hand signals or robots may guide the driving direction of the vehicles. However, this method has a drawback that vehicles approaching from behind may have difficulties in recognizing the situation from a distance and may not decrease a risk of the safety accident.

To solve the problem, road traffic signal vehicles disclosed in Korean Patent Publication Nos. 10-1931178, 10-2712180, and 10-2759875 provide guidance information on traffic control and available lanes on roads with two or more lanes by using a plurality of traffic signal boards mounted on a multi-stage boom.

However, since the multi-stage boom installed on the road traffic signal vehicles is extensible in only one direction, the road traffic signal vehicle needs to be used by disposing on the shoulder of the road.

Further, when the road traffic signal vehicle is disposed on one or more lanes of the road, the road traffic signal vehicle placed on the road cannot deploy the traffic signal boards across the entire width of the road lanes with the multi-stage boom that is extensible only in one direction. For example, in case where the road traffic signal vehicle is positioned on a second lane of a four-lane road to carry out the roadwork, the road traffic signal vehicle may deploy the traffic signal board over a single lane among a first and second lanes or among the second through fourth lanes.

As a result, when the road traffic signal vehicle is to be disposed on one or more lanes of the road, two or more road traffic signal vehicles may be required to deploy the traffic signal boards across all lanes of the road.

In the following description and the accompanied drawings, only parts necessary for understanding embodiments of the present disclosure will be described, and detailed descriptions of well-known functions or configuration that may obscure the subject matter of the present disclosure will be omitted for simplicity.

The terms and words used in the following description and appended claims are not necessarily to be construed in an ordinary sense or a dictionary meaning, and may be appropriately defined herein to be used as terms for describing the present disclosure in the best way possible. Such terms and words should be construed as meaning and concept consistent with the technical idea of the present disclosure. The embodiments described in this specification and the configurations shown in the drawings are merely preferred embodiments of the present disclosure are not intended to limit the technical idea of the present disclosure. Therefore, it should be understood that there may exist various equivalents and modifications which may substitute the exemplary embodiments at the time of filing of the present application.

Hereinbelow, exemplary embodiments of the present disclosure will be described in detail with reference to the accompanied drawings.

### First Embodiment

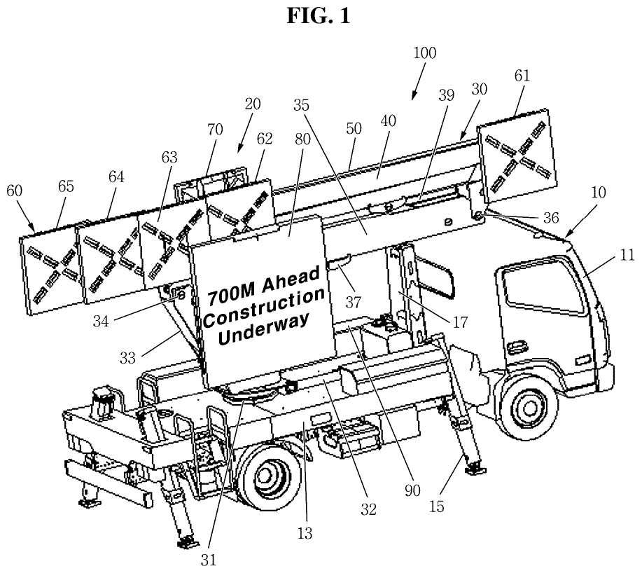

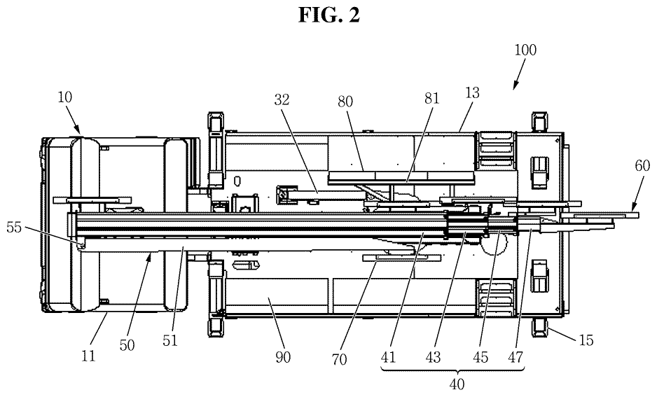

FIG. 1 is a perspective view showing a multi-stage boom of a road traffic signal vehicle according to a first exemplary embodiment of the present disclosure. FIG. 2 is a plan view of the road traffic signal vehicle shown in FIG. 1 and shows a state before a boom module is expanded.

Referring to FIGS. 1 and 2, a road traffic signal vehicle 100 according to the first embodiment is a drivable vehicle that may be disposed at a roadwork site to provide vehicles traveling on the road with a guidance on an availability of each lane and construction information.

The road traffic signal vehicle 100 according to the first embodiment may include a movable platform 13 and a road traffic signal device 20. The road traffic signal device 20 is installed on the movable platform 13 and may be configured to deploy traffic sign display panels 60 and 70 in both directions with respect to the movable platform 13. The road traffic signal device 20 may also deploy the traffic sign display panel 60 or 70 only in one direction, that is, either to the left or to the right with respect to the movable platform 13.

Since the road traffic signal vehicle 100 according to the first embodiment can deploy the traffic sign display panels 60 and 70 in both directions or only in one direction, the road traffic signal vehicle 100 may be disposed on a shoulder of the road as well as on one or more lanes of the road.

That is, since the road traffic signal vehicle 100 according to the first embodiment is capable of deploying the traffic sign display panels 60 and 70 in both directions with respect to the movable platform 13, the road traffic signal vehicle 100 can provide traffic signs by deploying the traffic sign display panels 60 and 70 over a plurality of lanes of the road while being disposed in the middle of the road. Thus, according to the first embodiment, just a single road traffic signal vehicle 100 disposed in the middle of the road on which the roadwork is underway can provide sufficient information to the vehicles driving toward the roadwork site and allows to perform a construction operation with an enhanced safety.

Meanwhile, in case where the traffic signal vehicle 100 according to the first embodiment is disposed on the shoulder of the road, only one traffic sign display panel 60 or 70 installed on the road side among the traffic sign display panels 60 and 70 may be deployed toward the lanes of the road similarly to an existing road traffic signal vehicle.

In addition, the road traffic signal device 20 according to the present embodiment may further include a roadwork information board 80, a control box 90, one or more outriggers 15, a mount stand 17, a work light, and a shock absorbing structure, but the present disclosure is not limited thereto.

Hereinbelow, the road traffic signal vehicle 100 according to the first embodiment will be described in more detail.

The movable platform 13 is transportable by the vehicle 10 and provides a space on which the road traffic signal device 20 may be installed. The movable platform 13 may be integrally installed on the vehicle 10 or detachably mounted to the vehicle 10. For example, the movable platform 13 may include a stage of the vehicle 10 or a trailer, but the present disclosure is not limited thereto. The road traffic signal vehicle according to the first embodiment shown in FIG. 1 depicts an example where the movable platform 13 is implemented by a stage of the vehicle 10.

The vehicle 10 may include a vehicle body 11 and the movable platform 13, i.e., the stage, coupled to the vehicle body 11. The vehicle 10 serves as a transport device for the road traffic signal device 20. The vehicle 10 may be a combustion engine vehicle, an electric vehicle, or a hybrid electric vehicle, for example. The vehicle 10 may include a vehicle body 11 and the stage 13 located behind the vehicle body 11. The vehicle body 11 may include a driver's cabin and additional components necessary for driving the vehicle 10. The movable platform 13 may provide a space where the road traffic signal device 20 is mounted. The stage, i.e., the movable platform 13, may be a loading space of the vehicle 10, a chassis or frame on which the vehicle body 11 is mounted.

The outriggers 91 may support the vehicle 10 when the road traffic signal device 20 is in operation. These outriggers 91 may be installed at the movable platform 13. In detail, the outriggers 91 may be installed on left and right sides at front and rear ends of the movable platform 13 to be expandable and retractable so as to stably support the vehicle 10 and thereby support the road traffic signal vehicle 100 on the ground. In a road traffic signal vehicle 100 according to an alternative embodiment of the present disclosure, the outriggers 15 may be omitted or may be used such that ranges of the outriggers 15 do not exceed a width of the vehicle 10 depending on the width of the vehicle 10 and a width of the shoulder or lane of the road on which the vehicle 10 is disposed.

The control box 90 allows an operator to control the operation of the road traffic signal device 20. The control box 90 is equipped with one or more valves, one or more levers, one or more buttons, and/or one or more joysticks for manipulating the road traffic signal device 20 and/or the outriggers 15. The control box 90 may be equipped with a display device such as a light emitting diode (LED) with a touch screen allowing the operator to check an operation status of the road traffic signal device 20 and/or the outriggers 15. In case where the LED with the touch screen is provided as a display device, the touch screen may function as an input device, and the input devices such as the valves, the levers, the buttons, and/or the joysticks may be omitted.

The control box 90 may be fixedly installed on the movable platform 13 or on the vehicle body 11, or may be implemented in a form of a portable terminal carried by a user. When the control box 90 is implemented in the form of a portable terminal, the user may operate the control box 90 while visually checking an operating status of the road traffic signal device 20 or the outriggers 15 from various positions around the vehicle 10.

The work light may be installed at an upper portion of the movable platform 13. For example, the work light may be mounted on a light pole installed on the movable platform 13. The work light may function to illuminate a roadwork site or to serve as a warning light to alert vehicles traveling around the roadwork site. A camera for capturing the roadwork site or traffic situation may be installed on the light pole on which the work light is mounted.

The shock absorbing structure may be installed at a side of the movable platform 13 opposite to the side at which the vehicle body 11 is coupled. That is, when the road traffic signal vehicle 100 is deployed on a traffic lane, an appropriate shock absorbing structure may be installed in consideration of a speed limit of the road.

The mount stand 17 may be installed on a portion of the movable platform 13 between the vehicle body 11 and a drive table 31 and supports a folded connecting frame 35 and multi-stage booms 40 and 50. In this case, an upper part of the mount stand on which the folded connecting frame 35 and the multi-stage booms 40 and 50 are mounted is positioned higher than an upper surface of the vehicle body 11.

The roadwork information board 80 displays information related to the roadwork being performed at the roadwork site through one or more light emitting elements. The roadwork information may be displayed using text and/or images. The roadwork information board 80 may be fixedly installed on a rotating frame 33 to be parallel to a surface on which the traffic sign display panels 60 and 70 are installed. The roadwork information board 80 may be fixed to the rotating frame 33 using one or brackets 81.

The road traffic signal device 20 may include a boom module 30 and the traffic sign display panels 60 and 70. The boom module 30 may include the multi-stage booms 40 and 50 that may be extended in both directions so as to span across a plurality of lanes of the road above the plurality of lanes. At least one of the traffic sign display panels 60 and 70 may be installed at the multi-stage booms 40 and 50. When the multi-stage booms 40 and 50 are deployed, each traffic sign display panel may be positioned over a corresponding lane of the road and indicate whether the corresponding lane is available for driving.

The boom module 30 may include the drive table 31, a drive cylinder 32, a rotating frame 33, the connecting frame 35, and the multi-stage booms 40 and 50. The drive table 31 is installed on the movable platform 13 to be rotatable in a horizontal direction. The drive cylinder 32 may be coupled to the drive table 31 through a mechanism converting a linear motion into a rotational motion and may perform a linear motion to rotate the drive table 31. The conversion mechanism may include at least one of a rack and a pinion, a crank and slider mechanism, and a cam and a follower, but the present disclosure is not limited thereto. The rotating frame 33 may be installed on the drive table 31. The multi-stage booms 40 and 50 may be coupled to the rotating frame 33 with an intervention of the connecting frame 35.

In addition, the boom module 30 may further include a first link cylinder 37 and a second link cylinder 39.

Here, the drive table 31 may be installed on the movable platform 13 such that its center is located on a center line of the vehicle 10 that is parallel to a longitudinal direction of the vehicle 10. The drive table 31 is rotatably mounted on the movable platform 13 such that a rotational axis of the drive table 31 may be supported at the movable platform 13. The drive table 31 may have a shape of a disc.

The drive cylinder 32 may be installed on the movable platform 13 to be spaced apart from the drive table 31 and may be coupled to an outer periphery or the rotational axis, for example, of the drive table 31 so that the drive cylinder 32 may apply a linear force to the drive table 31 in a horizontal direction parallel to an upper surface of the movable platform 13, thereby rotating the drive table 31. This drive cylinder 32 may be installed in an area on the movable platform 13 between the vehicle body 11 and the drive table 31. A hydraulic cylinder may be used as the drive cylinder 32.

Although the drive table 31 is rotated by the drive cylinder 32 in the first embodiment, the present disclosure is not limited thereto. For example, the rotational shaft of the drive table 31 may be coupled to a drive shaft of a drive motor, and the drive table 31 may be rotated 360 degrees clockwise or counterclockwise according to the rotation of the drive motor.

The drive table 31 may rotate to position the multi-stage booms 40 and 50 installed on the drive table to be parallel with a traveling direction of the vehicle 10 or to be perpendicular to the traveling direction of the vehicle 10. The multi-stage booms 40 and 50 may be positioned to be parallel with the traveling direction of the vehicle 10 when the multi-stage booms 40 and 50 is parked on the movable platform 13. The multi-stage booms 40 and 50 may be positioned to be perpendicular to the traveling direction of the vehicle 10 when the multi-stage booms 40 and 50 are deployed on one or more lanes of the road.

The rotating frame 33 may be installed on the drive table 31. The rotating frame 33 may be installed to have a certain incline angle to be leaned with respect to the drive table 31. As a result, when the rotating frame 33 rotates on the drive table 31, the rotating frame 33 may create a conical trajectory when viewed from a side or rear of the vehicle 10.

The connecting frame 35 couples the rotating frame 33 and the multi-stage booms 40 and 50. One end of the connecting frame 35 may be rotatably linked to an upper end of the rotating frame 33 with an intervention of a first hinge 34. The other end of the connecting frame 35 may be rotatably linked to one end of the multi-stage booms 40 and 50 with an intervention of a second hinge 36.

The first and second hinges 34 and 36 may be formed to be parallel with each other to enable the connecting frame 35 and the multi-stage booms 40 and 50 to expand upward and retract downward with respect to rotating frame 33 in a zigzag manner. Accordingly, the connecting frame 35 and the multi-stage booms 40 and 50 may be folded or unfolded in a zigzag configuration with respect to the rotating frame 33 extended in an inclined direction.

The rotating frame 33 and the connecting frame 35 may be coupled with an intervention of the first link cylinder 37. In this case, the connecting frame 35 may rotate to extend upward or retract downward with respect to the rotating frame 33 fixed vertically according to an extension and retraction of the first link cylinder 37.

The connecting frame 35 and a rearmost boom segment 41 of the multi-stage booms 40 and 50 may be coupled with an intervention of the second link cylinder 39. The multi-stage booms 40 and 50 may rotate to extend upward or retract downward with respect to the connecting frame 35 according to an extension and retraction of the second link cylinder 39. At this time, the second link cylinder 39 may extend and retract in conjunction with the extension and retraction of the first link cylinder 37, so that the multi-stage booms 40 and 50 may rotate with respect to the connecting frame 35 and maintain a state parallel to the ground.

Hydraulic cylinders may be used as the first and second link cylinders 37 and 39.

When the multi-stage booms 40 and 50 are loaded onto the movable platform 13, the rotating frame 33 is positioned parallel to the longitudinal direction of the movable platform 13, and the connecting frame 35 and the multi-stage booms 40 and 50 are positioned in a folded zigzag configuration relative to the rotating frame 33. At this time, each of the first and second link cylinders 37 and 39 is in a retracted state.

When the road traffic signal vehicle 100 is deployed at a roadwork site, the first link cylinder 37 may be extended to raise the connecting frame 35. Then, the drive cylinder 32 may rotate the drive table 31 to position the rotating frame 33, the connecting frame 35, and the multi-stage booms 40 and 50 to be perpendicular to the lanes of the road. Afterwards, the first link cylinder 37 may extend further to rotating and erect the connecting frame 35 to be perpendicular to the ground. At this time, the second link cylinder 39 may extend in conjunction with the first link cylinder 37 to raise the multi-stage booms 40 and 50 upward over the road while maintaining a horizontal orientation to be parallel with the road surface.

The multi-stage boom 140 and 150 may include a first multi-stage boom 140 and a second multi-stage boom 150. The first multi-stage boom 140 may be coupled to the connecting frame 35 and may be extended in a first direction. The second multi-stage boom 150 may be installed at one side of the first multi-stage boom 140 and may extended in a second direction opposite to the first direction in which the first multi-stage boom 140 may be extended.

The first multi-stage boom 140 may include a plurality of first boom segments expanding or retracting telescopically.

The first multi-stage boom 40 may include a plurality of boom segments that are expandable and retractable telescopically by rollers and wires or driven by a hydraulic cylinder system employing cable bays. The first multi-stage boom 40 may include a rearmost boom segment 41, a foremost boom segment 47, and one or more intermediate boom segments 43 and 45. The one or more intermediate boom segments 43 and 45 may be positioned between the rearmost boom segment 41 and the foremost boom segment 47. The rearmost boom segment 41 is the outermost boom segment of the multi-stage boom 40 or 50. The first multi-stage boom 40 according to the present embodiment may include two intermediate boom segments 43 and 45, for example, and thus include four stage boom segments. In other words, the first multi-stage boom 40 has a configuration that the rearmost boom segment 41, a first intermediate boom segment 43, a second intermediate boom segment 45, and the foremost boom segment 47 that are sequentially coupled.

In case where the first multi-stage boom 40 is expanded and retracted by a telescopic mechanism, the intermediate boom segments 43 and 45 and the foremost boom segment 47 may be expanded by a same length with respect to the rearmost boom segment 72.

In case where the first multi-stage boom 40 is expanded and retracted by a hydraulic cylinder system, the expansion and retraction of the first multi-stage boom 40 may vary depending on a number of hydraulic cylinders. For example, When the first multi-stage boom 40 includes two hydraulic cylinders, and the rearmost boom segment 41 and the first intermediate boom segment 43 are connected to a first hydraulic cylinder, and the second intermediate boom segment 45 and the foremost boom segment 47 are connected to a second hydraulic cylinder, the expansion of the first intermediate boom segment 43 and the expansion of the second intermediate boom segment 45 and the foremost boom segment 47 may be performed independently with respect to the rearmost boom segment 41.

The rearmost boom segment 41 may be unexpandable since the rearmost boom segment 41 is rotatably installed on the connecting frame 35 via the second hinge 36. The intermediate boom segments 43 and 45 and the foremost boom segment 47 may be sequentially inserted into the rearmost boom segment 41 in a nested manner.

The second multi-stage boom 50 may include one or more second boom segments and may be extended or folded by rotating around a third hinge provided at a connection point of the first multi-stage boom 40 and the second multi-stage boom 50 and elongated in a vertical direction. The second multi-stage boom 50 may be rotabably coupled to one end of the first multi-stage boom 40 opposite to the direction in which the first multi-stage boom 40 is expandable. When the second multi-stage boom 50 is folded, the second multi-stage boom 50 may be parked on one side of the first multi-stage boom 40. When the second multi-stage boom 50 is to be extended, the second multi-stage boom 50 may rotate around the third hinge toward the side opposite to the first direction in which the first multi-stage boom 40 is expanded and thus may be extended in the second direction opposite to the first direction in which the first multi-stage boom 40 is expanded.

According to the embodiment shown in the drawings, the second multi-stage boom 50 includes a single second boom segment 51. One end of the second boom segment 51 may be rotatably coupled to one end of the rearmost boom segment 41 of the first multi-stage boom 40. The rearmost boom segment 41 of the first multi-stage boom 40 and the second boom segment 51 of the second multi-stage boom 50 may be coupled such that the second boom segment 51 may be rotatable around the third hinge 55.

Although the second multi-stage boom 50 according to the present embodiment includes a single second boom segment 51, the present disclosure is not limited thereto. In an alternative embodiment, the second multi-stage boom 50 may include two boom segments, e.g., a first boom segment and a second boom segment. In this case, one end of the first boom segment of the second multi-stage boom 50 may be rotatably coupled to one end of the rearmost boom segment 41 of the first multi-stage boom 40, and the other end of the first boom segment of the second multi-stage boom 50 may be rotatably coupled to one end of the second boom segment of the second multi-stage boom 50. When the second multi-stage boom 50 is parked one side of the first multi-stage boom 40, the first and second boom segments of the second multi-stage boom 50 may be stacked beside the first multi-stage boom 40 in a zigzag configuration by an articulated manner. As mentioned above, the rearmost boom segment 41 of the first multi-stage boom 40 and the first boom segment of the second multi-stage boom 50 may be rotatably coupled at the third hinge. The first and second boom segments of the second multi-stage boom 50 may be rotatably coupled with an intervention of a fourth hinge.

The first multi-stage boom 40 may rotate around the second hinge 36 to extend to the opposite side of the connecting frame 35 with respect to the second hinge 36. The second multi-stage boom 50 may extend in the direction opposite to the direction in which the first multi-stage boom 40 is extended.

The traffic sign display panels 60 and 70 may be installed at the multi-stage booms 40 and 50. The traffic sign display panels 60 and 70 may be positioned over respective lanes of the road when the multi-stage booms 40 and 50 are deployed and may indicate whether the lanes are available for driving.

These traffic sign display panels 60 and 70 may include first traffic sign display panels 60 installed at the first multi-stage boom 40 and second traffic sign display panels 70 installed at the second multi-stage boom 50.

Each of the traffic sign display panels 60 and 70 may include one or more light-emitting elements capable of indicating the availability of the road or one or more lanes for driving. Each of the light-emitting elements may include one or more light emitting diodes (LEDs). The light-emitting elements may display the availability of the road or one or more lanes by a symbol or a text. Examples of symbols may include “X” indicating that the road or lane is unavailable, “O” indicating that the road or lane is available, or an arrow (e.g., “↓”) indicating an available lane or indicating that the road or lane is available, but the present disclosure is not limited thereto. In the first embodiment described herein, the traffic sign display panels 60 and 70 may be configured to display the symbols “X” and/or “↓”. That is, the traffic sign display panels 60 and 70 may display the symbol “X” by selectively turning on the light-emitting elements to indicate that the lane is unavailable. Meanwhile, the traffic sign display panels 60 and 70 may display the symbol “↓” by selectively turning on the light-emitting elements to indicate that the road or lane is available.

When the multi-stage booms 40 and 50 are retracted, interference may occur between the traffic sign display panels 60 and 70. To minimize the interference between the traffic sign display panels 60 and 70 while the multi-stage booms 40 and 50 are retracted, the traffic sign display panels 60 and 70 installed at adjacent boom segments may be spaced apart from each other in the front-to-back direction. The spacing may be greater than a thickness of each of the traffic sign display panels 60 and 70.

The traffic sign display panels 60 and 70 may be installed at the multi-stage booms 40 and 50 such that a traffic sign display panel positioned in the middle is disposed at the very front, adjacent traffic sign display panels outside the frontmost traffic sign display panel are disposed behind the frontmost traffic sign display panel with the spacing, and the remaining panels are sequentially disposed behind the previously disposed panels with the spacing.

According to the first embodiment where the first multi-stage boom 40 is composed of four stages, five first traffic sign display panels 60 may be installed on the first multi-stage boom 40. The first traffic sign display panels 60 may include a first through a fifth unit display panels. Specifically, the first and the second unit display panels may be installed at both ends of the rearmost boom segment 41, and the third through the fifth unit display panels may be installed at the first intermediate boom segment 43, the second intermediate boom segment 45, and the foremost boom segment 47, respectively. The first unit display panel may be unaffected by the expansion and retraction of the first multi-stage boom 40. When the multi-stage booms 40 and 50 are retracted, however, the interference or overlap may occur between the second through the fifth unit display panels. In this case, the third unit display panel may be positioned at the very front. The second unit display panel and the fourth unit display panel may be positioned on both sides behind the third unit display panel. The fifth unit display panel may be positioned behind the fourth unit display panel.

The traffic sign display panels 60 and 70 may be installed on one side or both sides of the multi-stage booms 40 and 50. According to the first embodiment shown in the drawings, the traffic sign display panels 60 and 70 may be installed on one side of the multi-stage booms 40 and 50.

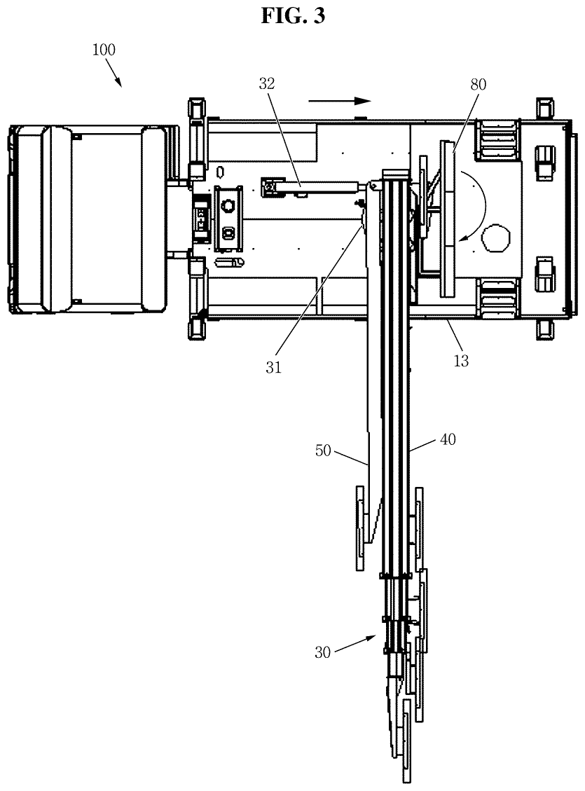

The deployment of the boom module 30 of the road traffic signal vehicle 100 according to the first embodiment deployed at a roadwork site will now be described in more detail with reference to FIGS. 1-6. FIGS. 3-6 are plan views of the road traffic signal vehicle showing the deployment of the boom module 30.

First, when the road traffic signal vehicle 100 moves, the folded connecting frame 35 and the multi-stage booms 40 and 50 are maintained in the parking state on the movable platform 13 as shown in FIGS. 1 and 2.

After the road traffic signal vehicle 100 moves to and arrives at a roadwork site, the deployment of the boom module 30 is initiated as shown in FIGS. 1-3. Here, FIG. 3 is a plan view of road traffic signal vehicle showing a state in which the multi-stage booms 40 and 50 are rotated to a direction perpendicular to the traveling direction of the vehicle for the deployment of the boom module 30.

First, the first and second link cylinders 37 and 39 are extended to raise the connecting frame 35 and the multi-stage booms 40 and 50. By extending the second link cylinder 39 in synchronicity with the first link cylinder 37, the multi-stage booms 40 and 50 may be raised to a certain height above the road while maintaining its horizontal posture that is parallel with the road surface.

Next, the drive table 31 is rotated according to the linear motion of the drive cylinder 32 to position the rotating frame 33, the connecting frame 35, and the multi-stage booms 40 and 50 to be perpendicular to the lanes of the road. At this time, the roadwork information board 80 changes its orientation to a direction perpendicular to the longitudinal direction of the movable platform 13 according to the rotation of the rotating frame 33 to face the vehicles behind the vehicle on the road. The roadwork information board 80 may display ongoing work details to be performed at the roadwork site toward the vehicles behind the vehicle on the road.

Subsequently, the second link cylinder 39 is further extended in synchronicity with the first link cylinder 37, so that the multi-stage booms 40 and 50 may be elevated to a certain installation height above the road while maintaining its horizontal posture that is parallel with the road surface.

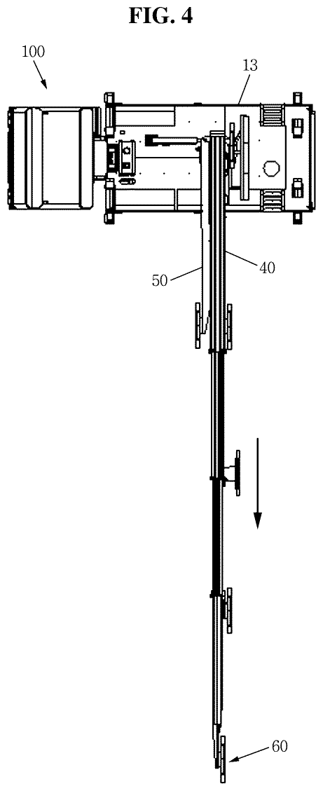

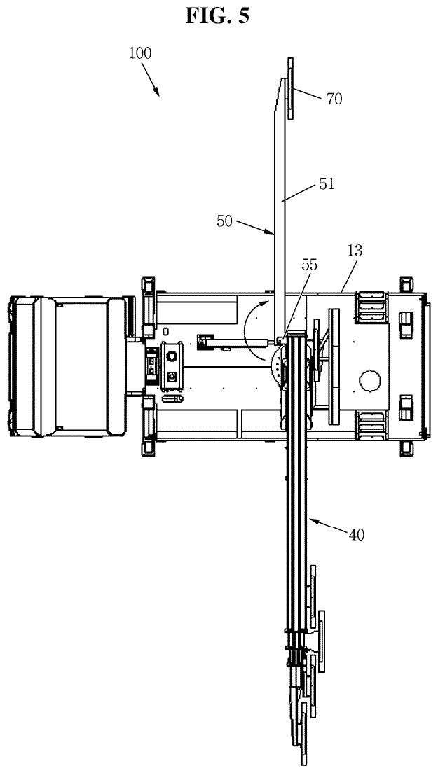

In case where the road traffic signal vehicle 100 is disposed on the shoulder of the road, the multi-stage booms 40 and 50 may deployed as shown in FIGS. 4-6. Here, FIG. 4 is a plan view of road traffic signal vehicle showing a state in which only the first multi-stage boom 40 among the two multi-stage booms 40 and 50 is deployed in one direction (i.e., to the left) with respect to the movable platform 13. FIG. 5 is a plan view of the road traffic signal vehicle showing a state in which the second multi-stage boom 50 among the multi-stage booms 40 and 50 is deployed in the other direction (i.e., to the right) with respect to the movable platform 13.

Referring to FIG. 4, when the road traffic signal vehicle 100 is disposed on the right shoulder of the road, only the first multi-stage boom 40 of the two multi-stage booms 40 and 50 may be deployed toward the lane side (i.e., to the left) with respect to the movable platform 13. That is, the first multi-stage boom 40 which has been retracted is expanded and positioned across a plurality of lanes on the road. The first multi-stage boom 40 may be deployed according to the number of lanes on the road. For example, in an exemplary embodiment, the first multi-stage boom 40 may be deployed to span four lanes. In this case, the first traffic sign display panels 60 may be positioned over respective lanes.

At this time, the second multi-stage boom 50 may maintain the retracted state.

Referring to FIG. 4, when the road traffic signal vehicle 100 is disposed on the left shoulder of the road, the second multi-stage boom 50 of the two multi-stage booms 40 and 50 may be deployed toward the lane side (i.e., to the right) with respect to the movable platform 13. Specifically, the second multi-stage boom 50 may rotate from the first multi-stage boom 40 and form an increasing angle with the first multi-stage boom 40. After the rotation, the second boom segment 51 is extended to form a straight line with the first multi-stage boom 40. As a result, the second multi-stage boom 50 which has been retracted may be deployed toward the lane side (i.e., to the right) positioned across one or more lanes on the road. The second multi-stage boom 50 extended with respect to the first multi-stage boom 40 may form a straight line with the first multi-stage boom 40 when viewed from the top.

At this time, the first multi-stage boom 40 may maintain the retracted state.

Although the second multi-stage boom 50 may rotate from the first multi-stage boom 40 and form an increasing angle with the first multi-stage boom 40 so that the second boom segment 51 is extended to form a straight line with the first multi-stage boom 40 according to the first exemplary embodiment, the present disclosure is not limited thereto. For example, in case where the second multi-stage boom 50 includes two or more boom segments, the first and second boom segments of the second multi-stage boom 50 may be sequentially rotated and deployed in a straight line.

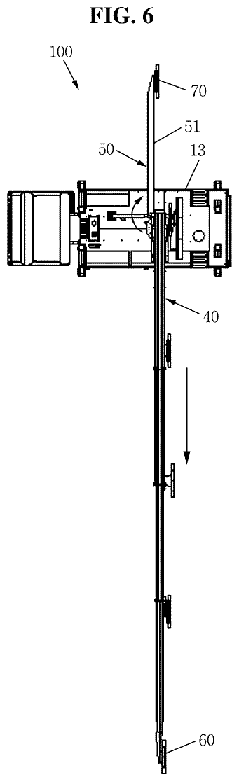

Meanwhile, in case where the road traffic signal vehicle 100 is disposed on a lane of the road, the multi-stage booms 40 and 50 may deployed in both directions as shown in FIG. 6. FIG. 6 is a plan view of the road traffic signal vehicle showing a state in which the first and second multi-stage booms 40 and 50 are deployed in both directions with respect to the movable platform 13.

Referring to FIG. 6, since there are lanes on both sides around the vehicle 10 located within a lane, the multi-stage booms 40 and 50 may are deployed in both directions. That is, the first multi-stage boom 40 of the two multi-stage booms 40 and 50 may be deployed toward a lane side (e.g., to the left) with respect to the movable platform 13. In addition, the second multi-stage boom 50 of the two multi-stage booms 40 and 50 may be deployed toward another lane side (e.g., to the right) with respect to the movable platform 13. The first and second multi-stage booms 40 and 50 deployed in respective directions may position the traffic sign display panels 60 and 70 over respective lanes of the road.

### Second Embodiment

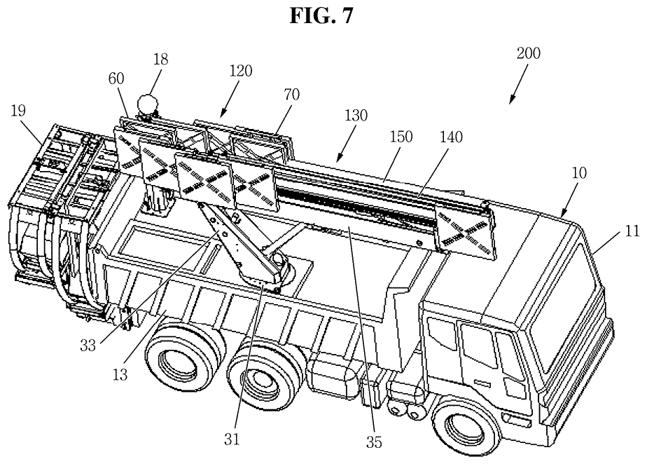

Although the drive table 31 is rotated in one direction by the drive cylinder 32 to deploy the multi-stage booms 40 and 50 in the boom module 30 according to the first embodiment, the present disclosure is not limited thereto. For example, the rotational shaft of the drive table 31 may be coupled to a drive shaft of a drive motor as shown in FIG. 7. The drive table 31 may be rotated 360 degrees clockwise or counterclockwise according to the rotation of the drive motor.

FIG. 7 is a perspective view showing multi-stage booms 140 and 150 of a road traffic signal vehicle 200 according to a second embodiment of the present disclosure.

Referring to FIG. 7, the road traffic signal vehicle 200 according to the second embodiment may include the movable platform 13 coupled to the vehicle body 11 and a road traffic signal device 120 installed on the movable platform 13 and capable of deploying the traffic sign display panels 60 and 70 in both directions with respect to the movable platform 13. The road traffic signal device 120 may also deploy the traffic sign display panels 60 and 70 only in one direction, that is, either to the left or to the right with respect to the movable platform 13.

The road traffic signal vehicle 200 may include a work light 18 installed on the movable platform 13, and a shock absorbing structure 19 installed at a rear end of the movable platform 13. Meanwhile, the road traffic signal vehicle 200 may not be provided with the outrigger or the roadwork information board.

The traffic sign display panels 60 and 70 may be installed on one side or both sides of the multi-stage booms 140 and 150. According to the second embodiment, the traffic sign display panels 60 and 70 may be installed on both side of the multi-stage booms 140 and 150.

The road traffic signal device 120 may include a boom module 130 and the traffic sign display panels 60 and 70. The boom module 130 may include the multi-stage booms 40 and 50 that may be extended in both directions so as to span across a plurality of lanes of the road above the plurality of lanes. At least one of the traffic sign display panels 60 and 70 may be installed at the multi-stage boom 140 and 150, so that each traffic sign display panel may be positioned over a corresponding lane of the road and indicate whether the corresponding lane is available for driving.

Since the multi-stage booms 140 and 150 have the same structure as the multi-stage booms according to the first embodiment, the description of the multi-stage booms 140 and 150 is omitted for simplicity.

The boom module 130 may include the drive table 31, a drive motor, the rotating frame 33, the connecting frame 35, and the multi-stage booms 140 and 150. The drive table 31 is installed on the movable platform 13 to be rotatable in the horizontal direction. The rotating frame 33 may be installed on the drive table 31. The multi-stage booms 140 and 150 may be coupled to the rotating frame 33 with an intervention of the connecting frame 35.

The drive table 31 may be installed on the movable platform 13 such that its center is located on the center line of the vehicle 10 that is parallel to the longitudinal direction of the vehicle 10. The drive table 31 is rotatably mounted on the movable platform 13 such that a rotational shaft of the drive table 31 may be supported at the movable platform 13. The drive table 31 may have a shape of a disc. The rotational shaft of the drive table 31 may be coupled to the drive shaft of the drive motor, and the drive table 31 may be rotated 360 degrees clockwise or counterclockwise according to the rotation of the drive motor.

Since the drive table 31 of the road traffic signal device 120 according to the second embodiment is capable of rotating 360 degrees, it is possible to changing the positions of the first and second multi-stage booms 140 and 150 with each other when they are deployed by rotating the first and second multi-stage booms 140 and 150 by 180 degrees.

There may be a difference in the number of boom segments of the first and second multi-stage booms 140 and 150. In this case, the first and second multi-stage booms 140 and 150 may be appropriately rotated and used according to the number of lanes of the road at the roadwork site where the road traffic signal vehicle 200 is deployed and according to the deployment position of the road traffic signal vehicle 200. For example, in case where the road traffic signal vehicle 200 is disposed in a lane and the number of remaining lanes on the left side relative to the lane on which the road traffic signal vehicle 200 is located is greater than and the number of remaining lanes on the right side, the road traffic signal device 120 may rotate the drive table 31 such that the multi-stage boom 140 or 150 having a relatively large number of boom segments among the first and second multi-stage booms 140 and 150 may be deployed toward the left lanes.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A road traffic signal vehicle, comprising:
a movable platform; and
a road traffic signal device installed on the movable platform and configured to deploy traffic sign display panels in both directions with respect to the movable platform.

2. The road traffic signal vehicle as claimed in claim 1, wherein the road traffic signal device comprises:
a boom module comprising a multi-stage boom configured to extend in both directions so as to span across a plurality of lanes of a road above the plurality of lanes; and
the traffic sign display panels installed at the multi-stage boom and configured to be movable to over a corresponding lane of the road in response to the multi-stage boom being deployed to indicate whether the corresponding lane is available for driving.

3. The road traffic signal vehicle as claimed in claim 2, wherein the boom module comprises:
a drive table installed on the movable platform to be rotatable in a horizontal direction;
a rotating frame installed on the drive table; and
the multi-stage boom coupled to the rotating frame with an intervention of a connecting frame.

4. The road traffic signal vehicle as claimed in claim 3, wherein the multi-stage boom comprises:
a first multi-stage boom coupled to the connecting frame and extensible in a first direction; and
a second multi-stage boom installed at one side of the first multi-stage boom and extensible in a second direction opposite to the first direction.

5. The road traffic signal vehicle as claimed in claim 4, wherein the first multi-stage boom comprises a plurality of first boom segments expanding or retracting telescopically, and
wherein the second multi-stage boom comprises one or more second boom segments and is extended or folded by rotating around one or more hinges.

6. The road traffic signal vehicle as claimed in claim 5, wherein the second multi-stage boom is rotabably coupled to one end of the first multi-stage boom opposite to the direction in which the first multi-stage boom is extensible,
wherein the second multi-stage boom is parked on one side of the first multi-stage boom in a folded state, and
wherein, in response to the second multi-stage boom being extended, the second multi-stage boom is configured to be rotated and extended to the second direction opposite to the first direction in which the first multi-stage boom is extended.

7. The road traffic signal vehicle as claimed in claim 3, wherein the traffic sign display panels are installed on one side or both sides of the multi-stage boom.

8. The road traffic signal vehicle as claimed in claim 1, further comprising at least one of:
a plurality of outriggers installed at the movable platform to be expandable and retractable so as to support the road traffic signal vehicle,
a work light installed at an upper portion of the movable platform, or
a shock absorbing structure installed at a side of the movable platform opposite to a side at which a vehicle body is coupled.

9. The road traffic signal vehicle as claimed in claim 1, wherein the road traffic signal device is configured to deploy the traffic sign display panels in only one direction with respect to the movable platform.

10. The road traffic signal vehicle as claimed in claim 1, wherein the movable platform comprises a stage of the road traffic signal vehicle or a trailer.

11. A road traffic signal device installed on a movable platform and configured to deploy traffic sign display panels in both directions with respect to the movable platform.
